(19) United States
(12) Patent Application Publication
(10) Pub. No.: US 2022/0198363 A1
(43) Pub. Date: Jun. 23, 2022

(54) COMPATIBILITY VERIFICATION OF DATA STANDARDS

(71) Applicant: International Business Machines Corporation, Armonk, NY (US)

(72) Inventors: Lisa Seacat DeLuca, Bozeman, MT (US); Filipe Avelino Correa, Sao Paulo (BR)

(21) Appl. No.: 17/128,263

(22) Filed: Dec. 21, 2020

(51) Int. Cl. G06Q 10/06; G06Q 30/00; G06Q 30/06

(52) U.S. Cl. CPC G06Q 10/06395; G06Q 30/0641; G06Q 30/018; G06Q 10/06312

(57) ABSTRACT

A set of standards to be used in a compatibility verification of one or more digital twin resources is received. A first digital twin resource added to a digital twin marketplace is analyzed. In response to determining that the first digital twin resource is not compatible with at least one standard in the set of standards based on the analysis, a non-compatibility badge associated with the first digital twin resource is displayed in a generated user interface associated with the digital twin marketplace.

### BACKGROUND

The present invention relates generally to the field of digital twin resources, and more particularly to providing for a verification of the compatibility of digital twin resource data standards in a digital twin marketplace (i.e., exchange).

A digital twin is a virtual representation of a physical object or system. Connected sensors on the physical object (i.e., asset) collect real-time data that is mapped to the virtual representation (i.e., model). The model uses the mapped data as input to output predictions or simulations of how the physical asset will be affected by the input. Digital twins integrate the Internet of Things (IoT), artificial intelligence (AI), machine learning (ML), and software analytics to generate the predictions and/or simulations. A digital twin marketplace (or exchange, store, etc.) connects the manufacturers and content providers of various physical assets (e.g., jet aircraft, mining equipment, railroad engines, manufacturing equipment, etc.) and the owners/operators of said assets; further, the marketplace provides the owners/operators a site for reviewing and purchasing digital twin resource content. Content available for purchase from the digital twin marketplace include, but are not limited to, a bill-of-materials, a parts list, one or more user manuals, one or more engineering manuals, one or more maintenance manuals, a set of maintenance plans, an operating model, augmented and virtual reality models, and one or more service manuals. Each of these digital twin resources can be released in a number of formats.

### SUMMARY OF THE INVENTION

Embodiments of the present invention include an approach for providing for a verification of the compatibility of digital twin resource data standards in a digital twin marketplace. In one embodiment, a set of standards to be used in a compatibility verification of one or more digital twin resources is received. A first digital twin resource added to a digital twin marketplace is analyzed. In response to determining that the first digital twin resource is not compatible with at least one standard in the set of standards based on the analysis, a non-compatibility badge associated with the first digital twin resource is displayed in a generated user interface associated with the digital twin marketplace.

### BRIEF DESCRIPTION OF THE DRAWINGS

FIG. 1 depicts a functional block diagram illustrating a computing environment which includes a verification program, in accordance with an embodiment of the present invention;

FIG. 2 is a flowchart depicting operational steps of a program for providing for a verification of the compatibility of digital twin resource data standards in a digital twin marketplace, on a computing device within the computing environment of FIG. 1, in accordance with an embodiment of the present invention;

FIG. 3 depicts an example screenshot of a user interface of a digital twin marketplace showing several digital twin resources, in accordance with an embodiment of the present invention; and

FIG. 4 depicts a block diagram of components of a computing device executing a verification program within the computing environment of FIG. 1, in accordance with an embodiment of the present invention.

### DETAILED DESCRIPTION

Embodiments of the present invention recognize that a single standard for digital twin resources does not exist. While various types of standards exist for a particular resource (e.g., a bill-of-material), the standards and associated file types vary widely between industries. The lack of a standard can lead to compatibility issues when a digital twin owner releases (i.e., loads) digital twin resources to a marketplace. A tool is needed that can verify the compatibility of digital twin resources for various asset management solutions.

Embodiments of the present invention recognize that there may be a method, computer program product, and computer system for providing for a verification of the compatibility of digital twin resource data standards in a digital twin marketplace. The method, computer program product, and computer system improve the technology of a digital twin marketplace by confirming that the various digital twin resources offered in the marketplace meet certain data standards. This verification of compatibility will provide a level of confidence to a purchaser of a digital twin resource that said resource will be compatible with the asset management tool(s) utilized by the purchaser. The verification will occur dynamically in real-time as digital twin resources are released to the marketplace by the resource owner. When a compatibility issue is identified between a resource and an asset management tool, said resource is indicated in the marketplace as not compatible with said asset management tool. Further, if the issue cannot be automatically resolved, the owner of the resource is notified.

In an embodiment, a set of standards is received. In the embodiment, an indication is received of a new digital twin resource being added to a digital twin marketplace. Further in the embodiment, the new digital twin resource is analyzed. Further yet in the embodiment, based on the analysis, a determination is made whether the new digital twin resource is compatible with one or more standards. Further yet in the embodiment, in response to determining that there are no compatibility issues, a compatibility badge is associated with the digital twin resource and the badge is displayed with the digital twin resource in the marketplace; further, a compatibility status is transmitted to the digital twin resource owner. Further yet in the embodiment, in response to determining that a compatibility issue exists, a non-compatibility badge is associated with the digital twin resource and displayed with the digital twin resource in the marketplace. Further yet in the embodiment, a determination is made whether the issue can be resolved automatically. Further yet in the embodiment, in response to determining that the issue cannot be resolved automatically, the non-compatibility status of the digital twin resource is transmitted to the digital twin resource owner. Further yet in the embodiment, in response to determining that the issue can be resolved automatically, the issue is corrected. Further yet in the embodiment, the non-compatibility badge is updated to a compatibility badge. Further yet in the embodiment, a status of the corrected issue and the updated badge is transmitted to the digital twin resource owner.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

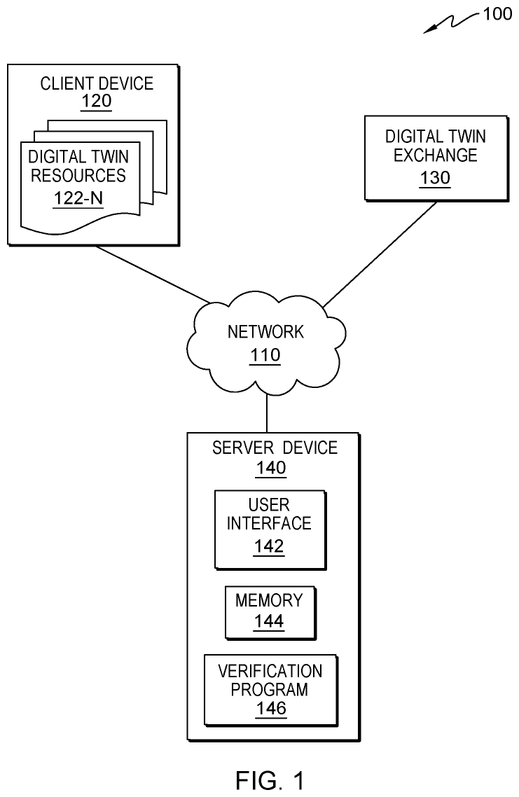

FIG. 1 is a functional block diagram illustrating a computing environment, generally designated 100, in accordance with one embodiment of the present invention. FIG. 1 provides only an illustration of one implementation of the present invention and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes client device 120, digital twin marketplace 130, and server device 140 interconnected by network 110. In example embodiments, computing environment 100 includes other computing devices (not shown in FIG. 1) such as additional wearable technology, cell phones, smartphones, phablets, tablet computers, laptop computers, desktop computers, other computer servers, or any other computer system known in the art, interconnected with client device 120, digital twin marketplace 130, and server device 140 over network 110.

In embodiments of the present invention, client device 120, digital twin marketplace 130, and server device 140 are connected to network 110, which enables client device 120, digital twin marketplace 130, and server device 140 to access other computing devices and/or data not directly stored on client device 120, digital twin marketplace 130, and server device 140. Network 110 may be, for example, a short-range, low power wireless connection, a local area network (LAN), a telecommunications network, a wide area network (WAN) such as the Internet, or any combination of the four, and include wired, wireless, or fiber optic connections. Network 110 includes one or more wired and/or wireless networks that are capable of receiving and transmitting data, voice, and/or video signals, including multimedia signals that include voice, data, and video information. In general, network 110 is any combination of connections and protocols that will support communications between client device 120, digital twin marketplace 130, and server device 140, and any other computing devices (not shown in FIG. 1) connected to network 110, in accordance with embodiments of the present invention.

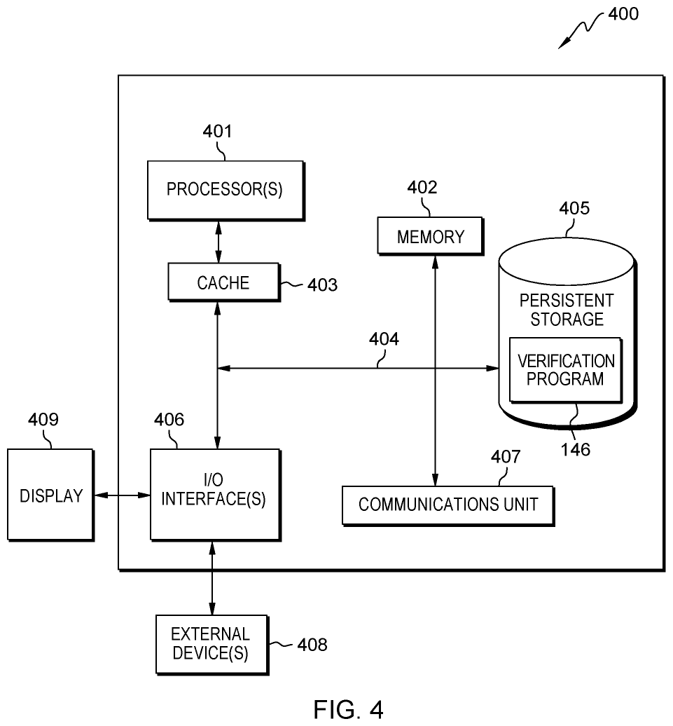

According to embodiments of the present invention, client device 120 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, client device 120 can be a standalone computing device, a management server, a web server, a mobile computing device, or any other electronic device or computing system capable of receiving, transmitting, and processing data. In other embodiments, client device 120 can represent computing systems utilizing multiple computers as a server system, such as in a cloud computing environment. In certain embodiments, client device 120 represents a computer system utilizing clustered computers and components (e.g., database server computers, application server computers, etc.) that act as a single pool of seamless resources when accessed by elements of computing environment 100. In general, client device 120 is representative of any electronic device or combination of electronic devices capable of executing computer readable program instructions. In an embodiment, computing environment 100 includes any number of server device 140. Client device 120 may include internal and external hardware components as depicted and described in further detail with respect to FIG. 4, in accordance with embodiments of the present invention. In an embodiment, client device 120 also includes digital twin resources 122-N.

In an embodiment, digital twin resources 122-N are a plurality (e.g., digital twin resource 122-1, digital twin resource 122-2, . . . digital twin resource 122-N) of digital twin resources which comprise the items that may become available for purchase from a digital twin content store (e.g., digital twin marketplace 130). According to an embodiment, a physical asset may have the following digital twin resources available for sale in digital twin marketplace 130 (note that the list is not exhaustive): a bill of material; a parts list; one or more user manuals; engineering manuals; fault codes; two and three dimensional computer aided design (CAD) files; augmented/virtual reality models; maintenance manuals; maintenance plans; one or more operating models; remote procedures for ‘technicians of the future’; a stocking strategy; building information models (BIM); service manuals; and the like. These resources are considered ‘digital twin templates’ because they are repeatable to any physical asset. The templates are the beginning to creating an ‘operating twin’ which is a one-to-one relationship between a digital and a physical asset. In an embodiment, digital twin resources 122-N are included in digital twin marketplace 130 in computing environment 100. In another embodiment, digital twin resources 122-N are included on client device 140 or on any other computing device accessible via network 110 in computing environment 100. In the embodiment, digital twin marketplace 130 may have any number of digital twin resources 122-N.

According to an embodiment of the present invention, digital twin marketplace 130 is a digital twin marketplace that offers digital twin resources, such as digital twin resources 122-N (discussed above), for sale to consumers. Owners/operators of physical assets such as heavy machinery, airplanes, mining equipment, construction equipment, etc., can visit digital twin marketplace 130, which is accessible over the Internet, to compare available resources of multiple manufacturers to aid in buying decisions for new equipment. In an embodiment, digital twin marketplace 130 is in computing environment 100. In another embodiment, digital twin marketplace 130 is on client device 120, server device 140, or any other computing device available via network 110 in computing environment 100. In the embodiment, there are any number of digital twin marketplace 130 in computing environment 100.

In an embodiment, server device 140 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, server device 140 can be a standalone computing device, a management server, a web server, a mobile computing device, or any other electronic device or computing system capable of receiving, transmitting, and processing data. In other embodiments, server device 140 can represent computing systems utilizing multiple computers as a server system, such as in a cloud computing environment. In certain embodiments, server device 140 represents a computer system utilizing clustered computers and components (e.g., database server computers, application server computers, etc.) that act as a single pool of seamless resources when accessed by elements of computing environment 100. In general, server device 140 is representative of any electronic device or combination of electronic devices capable of executing computer readable program instructions. In an embodiment, computing environment 100 includes any number of server device 140. Server device 140 may include internal and external hardware components as depicted and described in further detail with respect to FIG. 4, in accordance with embodiments of the present invention. In an embodiment, server device 140 also includes user interface (UI) 142, memory 144, and verification program 146.

In an embodiment, UI 142 provides an interface between a user of server device 140 and verification program 146. UI 142 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. UI 142 may also be mobile application software that provides an interface between server device 140 and verification program 146. Mobile application software, or an “app,” is a computer program designed to run on smartphones, tablet computers and other mobile devices. UI 142 enables a user of server device 140 to interact with client device 120, digital twin marketplace 130, verification program 146, any other programs and applications included on server device 140 (not shown in FIG. 1), and any other computing devices (not shown in FIG. 1).

According to an embodiment, memory 144 is storage that is written to and/or read by verification program 146, and any other programs and applications on client device 120, digital twin marketplace 130, and server device 140. In one embodiment, memory 144 resides on server device 140. In other embodiments, memory 144 resides on client device 120, on digital twin marketplace 130, on any other device (not shown in FIG. 1) in computing environment 100, in cloud storage, or on another computing device accessible via network 110. In yet another embodiment, memory 144 represents multiple storage devices within server device 140. Memory 144 may be implemented using any volatile or non-volatile storage media for storing information, as known in the art. For example, memory 144 may be implemented with a tape library, optical library, one or more independent hard disk drives, multiple hard disk drives in a redundant array of independent disks (RAID), solid-state drives (SSD), or random-access memory (RAM). Similarly, memory 144 may be implemented with any suitable storage architecture known in the art, such as a relational database, an object-oriented database, or one or more tables. In an embodiment of the present invention, client device 120, digital twin marketplace 130, verification program 146, and any other programs and applications (not shown in FIG. 1) operating on server device 140 may store, read, modify, or write data to memory 144. In an embodiment of the present invention, data stored to memory 144 includes, but is not limited to, a set of acceptable standards for digital twin resources for any number of asset management solutions utilized by purchasers of digital twin resources.

In an embodiment of the present invention, verification program 146 is a program, a subprogram of a larger program, an application, a plurality of applications, or mobile application software, which functions to provide a verification of the compatibility of digital twin resource data standards in a digital twin marketplace. A program is a sequence of instructions written to perform a specific task. In an embodiment, verification program 146 runs independently. In other embodiments, verification program 146 depends on system software and/or other programs (not shown in FIG. 1) to execute. According to an embodiment, verification program 146 is a cognitive system based on artificial intelligence utilizing machine learning and deep learning which analyzes digital twin resources to determine their compatibility with asset management solutions. When verification program 146 identifies a non-compatibility, verification program 146 automatically attempts to resolve the issue causing the non-compatibility. In one embodiment, verification program 146 functions as a stand-alone program residing on server device 140. In another embodiment, verification program 146 works in conjunction with other programs, applications, etc., found in computing environment 100. In yet another embodiment, verification program 146 resides on other computing devices such as client device 120 and digital twin marketplace 130 in computing environment 100, which are interconnected to server device 140 via network 110.

According to an embodiment, verification program 146 receives a set of standards. In the embodiment, verification program 146 receives an indication of a new digital twin resource being added to a digital twin marketplace. Further in the embodiment, verification program 146 analyzes the new digital twin resource. Further yet in the embodiment, verification program 146 determines whether the new digital twin resource is compatible with one or more standards based on the analysis. Further yet in the embodiment, responsive to determining that there are no compatibility issues, verification program 146 associates a compatibility badge with the new digital twin resource, displays the badge with the new digital twin resource in the digital twin marketplace, and transmits a compatibility status to the owner of the new digital twin resource. Further yet in the embodiment, responsive to determining that a compatibility issue exists, verification program 146 associates a non-compatibility badge with the new digital twin resource and displays said non-compatibility badge with the new digital twin resource in the digital twin marketplace. Further yet in the embodiment, a determination is made by verification program 146 whether the issue can be resolved automatically. Further yet in the embodiment, responsive to determining that the issue cannot be resolved automatically, verification program 146 transmits the non-compatibility status of the new digital twin resource to the owner of the new digital twin resource. Further yet in the embodiment, responsive to determining that the issue can be resolved automatically, verification program 146 automatically resolves the issue. Further yet in the embodiment, verification program 146 updates the non-compatibility badge to a compatibility badge. Further yet in the embodiment, verification program 146 transmits the compatibility status and the issue which was automatically corrected to the owner of the new digital twin resource.

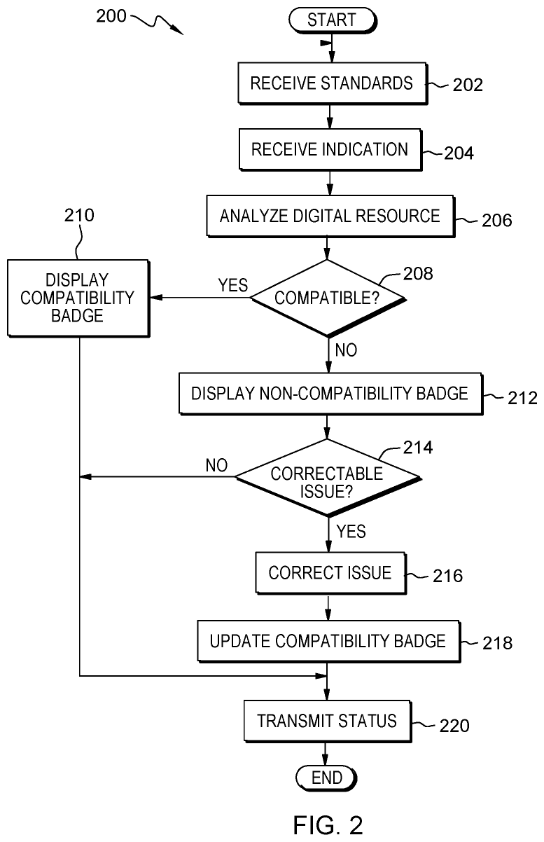

FIG. 2 is a flowchart of workflow 200 depicting operational steps for providing for a verification of the compatibility of digital twin resource data standards in a digital twin marketplace. In one embodiment, the method of workflow 200 is performed by verification program 146. In an alternative embodiment, the method of workflow 200 is performed by any other program in computing environment 100 working with verification program 146. In an embodiment, a user of server device 140 invokes workflow 200 upon accessing verification program 146. In an alternative embodiment, workflow 200 is dynamically invoked upon digital twin marketplace 130 receiving a new digital twin resource.

In an embodiment, verification program 146 receives standards (step 202). In other words, verification program 146 receives a set of standards or software applications to be used for a compatibility verification of digital twin resources in a digital twin marketplace. According to an embodiment, each standard in the set of standards defines the requirements which must be met by a digital twin resource for a certain asset management solution in order to receive a compatibility badge following the verification of verification program 146. Each standard in the set of standards (or set of software applications) may include (i) a set of rules which define the compatibility requirement for integration with asset management software; (ii) an example file which shows the correct format for compatibility; (iii) a template; and (iv) one or more test cases. In one embodiment, verification program 146 may receive an indication of a test environment and associated testing credentials for verification purposes. In an embodiment, verification program 146 receives a set of standards defining the compatibility requirements for one or more asset management tools and stores the set of standards to memory 144 on server device 140. For example, a program on a company server receives the following set of software standards: (i) standard ‘S1’ associated with asset management tool ‘AMT1’; (ii) standard ‘S2’ associated with asset management tool ‘AMT2’; (iii) standard ‘S3’ associated with asset management tool ‘AMT3’; (iv) standard ‘S4’ associated with asset management tool ‘AMT4’; and (v) standard ‘S5’ associated with asset management tool ‘AMT5’. The received set of standards is stored to a database on the company server by the program.

According to an embodiment of the present invention, verification program 146 receives an indication (step 204). In other words, verification program 146 receives an indication of at least one new digital twin resource being released (i.e., loaded) to a digital twin marketplace (i.e., content store). In an embodiment, the indication received by verification program 146 can be automatically generated by the digital twin exchange whenever a new digital twin resource is added to the digital twin marketplace. In another embodiment, a user may send an indication to verification program 146 when the new digital twin resource is added to the marketplace. The indication will identify the new digital twin resource(s) by name or some other identifier that can be recognized by verification program 146. According to an embodiment, verification program 146 receives an indication over network 110 of digital twin resources 122-N being added to digital twin marketplace 130. For example, the program on the company server receives an indication that the following three digital twin resources have been added to a digital twin content store: ‘DTR1’; ‘DTR2’; and ‘DTR3’. In the example, the provider (i.e., owner) of the resources has also indicated that ‘DTR1’ is compatible with ‘AMT2’, ‘DTR2’ is compatible with ‘AMT1’, and ‘DTR3’ is not compatible with any of ‘AMT1’ through ‘AMT5’.

In an embodiment, verification program 146 analyzes a digital resource (step 206). In other words, verification program 146 analyzes the newly released digital twin resources to verify the compatibility of each digital twin resource with known asset management tools defined by the set of previously received standards. According to an embodiment, verification program 146 analyzes each newly released digital twin resource by comparing the resource to the compatibility rules received in the set of standards (e.g., the elements in an Extensible Markup Language (i.e., XML) document must meet the requirements of the XML Schema (i.e., XSD), and a file formatted in YAML (i.e., YAML Ain′t Markup Language) must meet the requirements of the JSON (JavaScript Object Notation) schema. When a digital twin resource meets the requirements of at least one set of standards, said resource is deemed compatible with the asset management tool associated with the set of standards. Conversely, if a resource does not meet the requirements of at least one set of standards, said resource is deemed not-compatible with any of the asset management tools associated with the received set of standards. In an embodiment, verification program 146 analyzes digital twin resources 122-N against the received set of standards stored to memory 144. For example, ‘DTR1’ is analyzed for compatibility with ‘S1’ through ‘S5’. Similarly, ‘DTR2’ and ‘DTR3’ are also analyzed for compatibility with ‘S1’ through ‘ S5’.

According to an embodiment, verification program 146 determines whether a compatibility issue is identified (decision step 208). In other words, verification program 146 determines, based on the previous analysis of the digital twin resources, whether a digital twin resource meets the compatibility requirements for functioning correctly with known asset management tools (i.e., solutions) per the previously received standards. In one embodiment (decision step 208, YES branch), verification program 146 determines that a digital twin resource is compatible with at least one asset management tool; therefore, verification program 146 proceeds to step 210 to display a compatibility badge. In the embodiment (decision step 208, NO branch), verification program 146 determines that a digital twin resource is not compatible with any of the asset management tools associated with the previously received standards; therefore, verification program 146 proceeds to step 212 to display a non-compatibility badge.

In an embodiment, verification program 146 displays a compatibility badge (step 210). In other words, responsive to determining that the digital twin resource is compatible with at least one asset management tool, verification program 146 displays, in the user interface of the digital twin content store, a compatibility badge associated with the at least one asset management tool. According to an embodiment, a badge is a visual indicator, often containing the insignia of an organization, which is presented or displayed to indicate that an item (e.g., a digital twin resource) is compatible with the organization (e.g., a software standard). The badge may include a name and version number of any compatible software standard. The badge may be color coded to indicate compatibility (e.g., green indicates compatibility while red indicates not compatible) and/or it may include shading or fill patterns. The badge may include a symbol to indicate compatibility (e.g., a checkmark indicates compatibility and an exclamation point indicates not compatible). Any combination of colors and symbols can be used. The badge can be displayed with the digital twin resource in a generated user interface of the digital twin marketplace or the badge can be displayed on a summary compatibility page which summarizes the asset management tool compatibility of all of the digital twin resources included in the digital twin marketplace. In an embodiment, verification program 146 displays a compatibility badge for the digital twin resource 122-N in the user interface of digital twin marketplace 130. For example, based on the compatibility determination made by the program on the company server, a first badge indicating compatibility with ‘AMT2’ is displayed alongside ‘DTR1’ in a user interface of a digital twin content store and a second badge indicating compatibility with ‘AMT1’ is displayed alongside ‘DTR2’ in the user interface of the digital twin content store. The first badge is a circle outlined in black with a green checkmark on a white background inside said circle. The second badge is a rectangle shape outlined in green with the words ‘ATM1 COMPATIBLE’ in green on a white background inside said rectangle.

According to an embodiment, verification program 146 displays a non-compatibility badge (step 212). In other words, responsive to determining that the digital twin resource is not compatible with at least one asset management tool, verification program 146 displays, in the user interface of the digital twin content store, the digital twin resource and a non-compatibility badge associated with the set of standards previously received. In an embodiment, the non-compatibility badge may be as described above and may indicate that the associated digital twin resource is not-compatible with at least one standard. In another embodiment, the non-compatibility badge may include a list of names of non-compatible standards which is displayed when a user hovers a mouse cursor over the non-compatibility badge. In yet another embodiment, the non-compatibility badge may act as a hyperlink and when clicked, opens a new page in a new browser window in which non-compatible standards associated with the digital twin resource are displayed. According to an embodiment of the present invention, verification program 146 displays a non-compatibility badge alongside digital twin resources 122-N in the user interface of digital twin marketplace 130. For example, based on the non-compatibility determination made by the program on the company server, a badge indicating non-compatibility with ‘AMT1’, ‘AMT2’, ‘AMT3’, ‘AMT4’, and ‘AMT5’ is displayed alongside ‘DTR3’ in a user interface of a digital twin content store. The badge is an equilateral triangle outlined in red with a black exclamation point on a yellow background inside said triangle.

In an embodiment, verification program 146 determines whether the identified compatibility issue is a correctable issue (decision step 214). In other words, verification program 146 determines whether verification program 146 can automatically correct the non-compatibility issue (i.e., the issue which causes the incompatibility with at least one standard in the set of received standards). According to an embodiment, issues that can be automatically corrected include, but are not limited to, a date format and a syntax error (e.g., an extra space or a missing backward slash). In an embodiment (decision step 214, NO branch), verification program 146 determines that the non-compatibility issue cannot be automatically corrected; therefore, verification program 146 proceeds to step 220 to transmit a status. In the embodiment (decision step 214, YES branch), verification program 146 determines that the non-compatibility issue can be automatically corrected; therefore, verification program 146 proceeds to step 216 to correct the issue.

According to an embodiment of the present invention, verification program 146 corrects the issue (step 216). In other words, responsive to determining that the non-compatibility issue can be automatically corrected, verification program 146 automatically corrects the issue. In an embodiment, verification program 146 automatically corrects the non-compatibility issue by changing the date format or correcting the syntax in the file associated with the digital twin resource. According to an embodiment, verification program 146 automatically corrects the non-compatibility issue associated with digital resource 122-N released over network 110 to digital twin marketplace 130. For example, the program on the company server edits the file associated with ‘DTR3’ to correct the date format from the incorrect format of ‘20/06/08’ to the correct format of ‘06/08/2020’. Once the update is made, ‘DTR3’ becomes compatible with ‘AMT4’ based on another analysis of ‘DTR3’ against software standard ‘ S4’.

In an embodiment, verification program 146 updates the compatibility badge (step 218). In other words, verification program 146 updates the non-compatibility badge to a compatibility badge based on the non-compatibility issue being automatically corrected. Please refer to the previous discussion of compatibility badges for a description of said badge. In an embodiment, verification program 146 updates the non-compatibility badge associated with digital twin resources 122-N to a compatibility badge; the updated badge is now displayed alongside digital twin resources in the user interface of digital twin marketplace 130. For example, the program on the company server updates the previously described equilateral triangle, associated with ‘DTR3’, to a ten-sided star which is outlined in dark green with a light green background inside the ten-sided star. This ten-sided star indicates that “DTR3′ is compatible with ‘AMT4’.

According to an embodiment, verification program 146 transmits status (step 220). In other words, verification program 146 transmits a status for the newly released digital twin resources to the owner (or provider) of said resources. In a first embodiment (from step 208), verification program 146 transmits a status indicating that the digital twin resource(s) released to the digital twin marketplace are compatible with at least one asset management tool and said resource(s) have been tagged with compatibility badges. In a second embodiment (from step 214), verification program 146 transmits a status indicating that the digital twin resource(s) released to the digital twin marketplace are not compatible with the standards used by said marketplace and the non-compatibility issue could not be automatically corrected; further said resources have been tagged with non-compatibility badges. In a third embodiment, verification program 146 transmits a status indicating that a non-compatibility issue was automatically corrected, and the appropriate badge has been associated with the digital twin resource(s). Further, the issue that was automatically corrected is also documented so that said issue will not be repeated in the future. According to an embodiment, verification program 146 transmits a status over network 110 to the provider (i.e., owner) of digital twin resources 122-N on client device 120. For example, the program on the company server transmits a first status to the provider of ‘DTR1’ and ‘DTR2’ indicating that neither resource had a compatibility issue, and both are released in the digital twin content store with the appropriate badges. The program also transmits a second status to the provider of ‘DTR3’ indicating that the resource had a non-compatibility issue caused by the date format which has been automatically corrected. Following the automatic correction, a previously assigned non-compatibility badge was updated to a compatibility badge indicating compatibility with ‘AMT4’.

The following paragraphs discuss briefly some other embodiments where verification program 146 provides improvement to the digital twin marketplace.

In a first embodiment, upon the sale of a digital twin resource with a compatibility badge, verification program 146 can request feedback from the purchaser of the digital twin resource confirming compatibility with the asset management tools utilized by the purchaser. Should any discrepancies be identified (i.e., the purchaser discovers a compatibility issue with a digital twin resource that was tagged with a compatibility badge), verification program 146 can utilize machine learning to self-train based on the feedback from the purchaser.

In a second embodiment, verification program 146 will confirm a badge associated with a digital twin resource which has been provided by the resource owner before releasing said resource to the digital twin marketplace. For example, if an owner indicates that ‘DTRx’ is compatible with ‘AMTx’, verification program 146 will analyze ‘DTRx’ to confirm the compatibility. If found compatible, verification program 146 will utilize the badge provided by the owner. If found not compatible, verification program 146 will prevent the badge from the owner from displaying and will instead tag the resource with a non-compatibility badge.

In a third embodiment, the badge tagging by verification program 146 allows digital twin resources to be searched within the digital twin marketplace so that a potential purchaser is able to identify specific resources that meet certain compatibility requirements. In this manner, the potential purchaser is able to refine the available products in the marketplace and only view the resources that meet the needs of the purchaser (from a compatibility perspective).

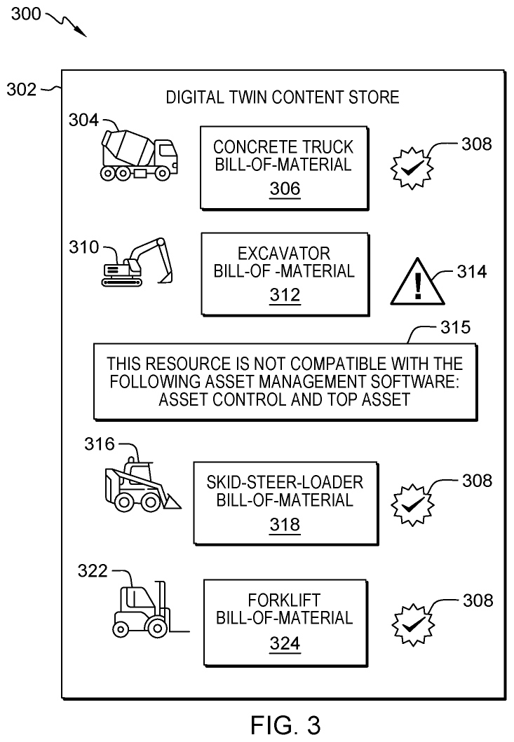

FIG. 3 depicts an example 300 of user interface (UI) 302 of a digital twin marketplace (i.e., content store). Verification program 146 generates UI 302 upon the releasing (i.e., loading) of a new digital twin resource to the digital twin exchange. Further, based on the previously described analysis, verification program 146 associates one of a compatibility badge or a non-compatibility badge with the new digital twin resource based on the results of the analysis. Including the badge is an improvement to the generated UI 302 as more information is presented in said UI. UI 302 includes concrete truck icon 304, concrete truck bill-of-material 306, compatibility badge 308 (in three separate and distinct locations), excavator icon 310, excavator bill-of-material 312, non-compatibility badge 314, pop-up message 315, skid-steer loader icon 316, skid-steer loader bill-of-material 318, forklift icon 322, and forklift bill-of-material 324. When verification program 146 analyzes excavator bill-of-material 312 and determines it is not compatible with any of the received set of standards, verification program 146 tags excavator bill-of-material 312 with non-compatibility badge 314. A user viewing screenshot 302 is able to place the mouse curser on top of non-compatibility badge 314 causing pop-up message 315 to be displayed. Pop-up message 315 indicates that excavator bill-of-material 312 is not compatible with (i) the ‘Asset Control’ asset management tool and (ii) the ‘Top Asset’ asset management tool. Thus, if the user utilizes one of ‘Asset Control’ or ‘Top Asset’, the user knows to try to avoid excavator bill-of-material 312 (or at least to be aware of a compatibility issue).

FIG. 4 depicts computer system 400, which is an example of a system that includes verification program 146. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. PO interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method, the method comprising:
receiving, by one or more computer processors, a set of standards to be used in a compatibility verification of one or more digital twin resources;
analyzing, by one or more computer processors, a first digital twin resource added to a digital twin marketplace; and
responsive to determining that the first digital twin resource is not compatible with at least one standard in the set of standards based on the analysis, displaying, by one or more computer processors, a non-compatibility badge associated with the first digital twin resource in a generated user interface associated with the digital twin marketplace.

2. The method of claim 1, further comprising:
responsive to determining that the first digital twin resource is compatible with at least one standard in the set of standards based on the analysis, displaying, by one or more computer processors, a compatibility badge associated with the first digital twin resource in the generated user interface associated with the digital twin marketplace; and
transmitting, by one or more computer processors, a first status to an owner of the first digital twin resource which indicates that the first digital twin resource was assigned the compatibility badge.

3. The method of claim 1, wherein the non-compatibility badge:
indicates that the first digital twin resource is not compatible with at least one standard in the received set of standards;
may include a listing of non-compatible standards from the received set of standards which is displayed in the generated user interface when a user hovers a mouse cursor over the non-compatibility badge; and
may act as a hyperlink that when clicked by the user, opens a new page in the generated user interface in which the listing of non-compatible standards are displayed to the user.

4. The method of claim 1, further comprising:
responsive to displaying the non-compatibility badge, determining, by one or more computer processors, whether an issue which causes the first digital twin resource to be incompatible with at least one standard in the set of standards is a correctable issue; and
responsive to determining that the issue which causes the first digital twin resource to be incompatible with at least one standard in the set of standards is a correctable issue, correcting, by one or more computer processors, the issue automatically.

5. The method of claim 4, further comprising:
responsive to determining that the issue which causes the first digital twin resource to be incompatible with at least one standard in the set of standards is not a correctable issue, transmitting, by one or more computer processors, a second status to an owner of the first digital twin resource which indicates that the first digital twin resource is assigned the non-compatibility badge and the issue causing the first digital twin resource to be incompatible with the at least one standard in the set of standards cannot be automatically corrected.

6. The method of claim 4, further comprising:
updating, by one or more computer processors, the non-compatibility badge to the compatibility badge; and
transmitting, by one or more computer processors, a third status to the owner of the first digital twin resource which indicates that the issue which caused the first digital twin resource to be incompatible with the at least one standard in the set of standards has been automatically corrected and a previously assigned non-compatibility badge has been updated to the compatibility badge.

7. The method of claim 1, wherein the step of analyzing, by one or more computer processors, a first digital twin resource added to a digital twin marketplace, comprises:
comparing, by one or more computer processors, the first digital twin resource to one or more compatibility rules included in the received set of standards; and
determining, by one or more computer processors, whether the first digital twin resource meets the one or more compatibility rules.

8. A computer program product, the computer program product comprising:
one or more computer readable storage media; and
program instructions stored on the one or more computer readable storage media, the program instructions comprising:
program instructions to receive a set of standards to be used in a compatibility verification of one or more digital twin resources;
program instructions to analyze a first digital twin resource added to a digital twin marketplace; and
responsive to determining that the first digital twin resource is not compatible with at least one standard in the set of standards based on the analysis, program instructions to display a non-compatibility badge associated with the first digital twin resource in a generated user interface associated with the digital twin marketplace.

9. The computer program product of claim 8, further comprising program instructions stored on the one or more computer readable storage media, to:
responsive to determining that the first digital twin resource is compatible with at least one standard in the set of standards based on the analysis, display a compatibility badge associated with the first digital twin resource in the generated user interface associated with the digital twin marketplace; and
transmit a first status to an owner of the first digital twin resource which indicates that the first digital twin resource was assigned the compatibility badge.

10. The computer program product of claim 8, wherein the non-compatibility badge:
indicates that the first digital twin resource is not compatible with at least one standard in the received set of standards;
may include a listing of non-compatible standards from the received set of standards which is displayed in the generated user interface when a user hovers a mouse cursor over the non-compatibility badge; and
may act as a hyperlink that when clicked by the user, opens a new page in the generated user interface in which the listing of non-compatible standards are displayed to the user.

11. The computer program product of claim 8, further comprising program instructions stored on the one or more computer readable storage media, to:
responsive to displaying the non-compatibility badge, determine whether an issue which causes the first digital twin resource to be incompatible with at least one standard in the set of standards is a correctable issue; and
responsive to determining that the issue which causes the first digital twin resource to be incompatible with at least one standard in the set of standards is a correctable issue, correct the issue automatically.

12. The computer program product of claim 11, further comprising program instructions stored on the one or more computer readable storage media, to:
responsive to determining that the issue which causes the first digital twin resource to be incompatible with at least one standard in the set of standards is not a correctable issue, transmit a second status to an owner of the first digital twin resource which indicates that the first digital twin resource is assigned the non-compatibility badge and the issue causing the first digital twin resource to be incompatible with the at least one standard in the set of standards cannot be automatically corrected.

13. The computer program product of claim 11, further comprising program instructions stored on the one or more computer readable storage media, to:
update the non-compatibility badge to the compatibility badge; and
transmit a third status to the owner of the first digital twin resource which indicates that the issue which caused the first digital twin resource to be incompatible with the at least one standard in the set of standards has been automatically corrected and a previously assigned non-compatibility badge has been updated to the compatibility badge.

14. The computer program product of claim 8, wherein the program instructions to analyze a first digital twin resource added to a digital twin marketplace, comprise:
program instructions to compare the first digital twin resource to one or more compatibility rules included in the received set of standards; and
determine whether the first digital twin resource meets the one or more compatibility rules.

15. A computer system, the computer system comprising:
one or more computer processors;
one or more computer readable storage media; and
program instructions stored on the one or more computer readable storage media for execution by at least one of the one or more computer processors, the program instructions comprising:
program instructions to program instructions to receive a set of standards to be used in a compatibility verification of one or more digital twin resources;
program instructions to analyze a first digital twin resource added to a digital twin marketplace; and
responsive to determining that the first digital twin resource is not compatible with at least one standard in the set of standards based on the analysis, program instructions to display a non-compatibility badge associated with the first digital twin resource in a generated user interface associated with the digital twin marketplace.

16. The computer system of claim 15, further comprising program instructions stored on the one or more computer readable storage media for execution by at least one of the one or more computer processors, to:
responsive to determining that the first digital twin resource is compatible with at least one standard in the set of standards based on the analysis, display a compatibility badge associated with the first digital twin resource in the generated user interface associated with the digital twin marketplace; and
transmit a first status to an owner of the first digital twin resource which indicates that the first digital twin resource was assigned the compatibility badge.

17. The computer system of claim 15, wherein the non-compatibility badge:
indicates that the first digital twin resource is not compatible with at least one standard in the received set of standards;
may include a listing of non-compatible standards from the received set of standards which is displayed in the generated user interface when a user hovers a mouse cursor over the non-compatibility badge; and
may act as a hyperlink that when clicked by the user, opens a new page in the generated user interface in which the listing of non-compatible standards are displayed to the user.

18. The computer system of claim 15, further comprising program instructions stored on the one or more computer readable storage media for execution by at least one of the one or more computer processors, to:
responsive to displaying the non-compatibility badge, determine whether an issue which causes the first digital twin resource to be incompatible with at least one standard in the set of standards is a correctable issue; and
responsive to determining that the issue which causes the first digital twin resource to be incompatible with at least one standard in the set of standards is a correctable issue, correct the issue automatically.

19. The computer system of claim 18, further comprising program instructions stored on the one or more computer readable storage media for execution by at least one of the one or more computer processors, to:
responsive to determining that the issue which causes the first digital twin resource to be incompatible with at least one standard in the set of standards is not a correctable issue, transmit a second status to an owner of the first digital twin resource which indicates that the first digital twin resource is assigned the non-compatibility badge and the issue causing the first digital twin resource to be incompatible with the at least one standard in the set of standards cannot be automatically corrected.

20. The computer system of claim 18, further comprising program instructions stored on the one or more computer readable storage media for execution by at least one of the one or more computer processors, to:
update the non-compatibility badge to the compatibility badge; and
transmit a third status to the owner of the first digital twin resource which indicates that the issue which caused the first digital twin resource to be incompatible with the at least one standard in the set of standards has been automatically corrected and a previously assigned non-compatibility badge has been updated to the compatibility badge.
